(19) United States
(12) Patent Application Publication
(10) Pub. No.: US 2008/0124053 A1
(43) Pub. Date: May 29, 2008

(54) Method for using a video content recording apparatus with syntax for video content recording parameters

(76) Inventor: Matthijs C. Hutten, Redwood City, CA (US)

Correspondence Address: BRINKS HOFER GILSON & LIONE/SanDisk, P.O. BOX 10395, CHICAGO, IL, 60610, US

(21) Appl. No.: 11/514,471

(22) Filed: Sep. 1, 2006

(51) Int. Cl. H04N 7/26

(52) U.S. Cl. 386/124

(57) ABSTRACT

A method for using a video content recording apparatus with syntax for video content recording parameters is disclosed. In one preferred embodiment, a method is disclosed comprising the acts of receiving video content, receiving a removable memory device, receiving a code formatted in accordance with a syntax in which values of video content recording parameters are represented by characters arranged in a predefined order, and recording the video content onto the removable memory device in accordance with the values of the video content recording parameters specified by the code. Other embodiments are disclosed, and each of the embodiments can be used alone or together in combination.

### BACKGROUND

In the past decade, advances have been made to provide consumers with enhanced control over the timing of video content recording and playback. For example, digital video recorders (“DVRs”) allow consumers to more easily record video content, as compared to using a video cassette recorder (“VCR”), and allow consumers to playback the video content whenever they like—even during the recording of the video content. Because most DVRs use a hard drive to store video content, the stored video content is often “tied” to the display device (e.g., television) connected to the DVR, restricting where the consumer can playback the video content. Devices are available that record video content onto a removable memory card. Once the video content is recorded, the memory card can be removed from the recording device and inserted into a portable playback device, such as a computer, smart phone, or portable media player. This allows consumers to watch video content whenever they want and wherever they want.

### SUMMARY

The present invention is defined by the following claims, and nothing in this section should be taken as a limitation on those claims.

By way of introduction, the preferred embodiments described below provide a method for using a video content recording apparatus with syntax for video content recording parameters. In one preferred embodiment, a method is disclosed comprising the acts of receiving video content, receiving a removable memory device, receiving a code formatted in accordance with a syntax in which values of video content recording parameters are represented by characters arranged in a predefined order, and recording the video content onto the removable memory device in accordance with the values of the video content recording parameters specified by the code.

In another embodiment, a method is disclosed comprising providing a video content recording apparatus (the video content recording apparatus comprising a first input configured to receive video content, a second input configured to receive a removable memory device, a third input configured to receive a code formatted in accordance with a syntax in which values of video content recording parameters are represented by characters arranged in a predefined order, and circuitry operative to record the video content onto the removable memory device in accordance with the values of the video content recording parameters specified by the code) and publishing the code.

In yet another embodiment, a method is disclosed comprising displaying a graphical user interface that facilitates user entry of a code formatted in accordance with a syntax in which values of video content recording parameters are represented by characters arranged in a predefined order, receiving the code, and recording video content onto a removable memory device in accordance with the values of the video content recording parameters specified by the code.

Other embodiments are disclosed, and each of the embodiments can be used alone or together in combination.

The preferred embodiments will now be described with reference to the attached drawings.

### BRIEF DESCRIPTION OF THE DRAWINGS

FIG. 1 is an illustration of a system of an embodiment for video content recording.

FIG. 2 is an illustration of an operation of a video content recording system of an embodiment.

FIG. 3 is a block diagram of a video content recording apparatus of an embodiment.

FIG. 4 is a display screen of a graphical user interface of an embodiment that facilitates selection a target playback device.

FIG. 5 is a display screen of a graphical user interface of an embodiment that facilitates manual entry of video content recording parameters.

FIG. 6 is a display screen of a graphical user interface of an embodiment that facilitates manual entry of a code for a target playback device.

FIG. 7 is a chart illustrating a syntax of video content recording parameters of an embodiment.

FIG. 8 is a list of exemplary codes for various playback devices of an embodiment.

### DETAILED DESCRIPTION OF THE PRESENTLY PREFERRED EMBODIMENTS

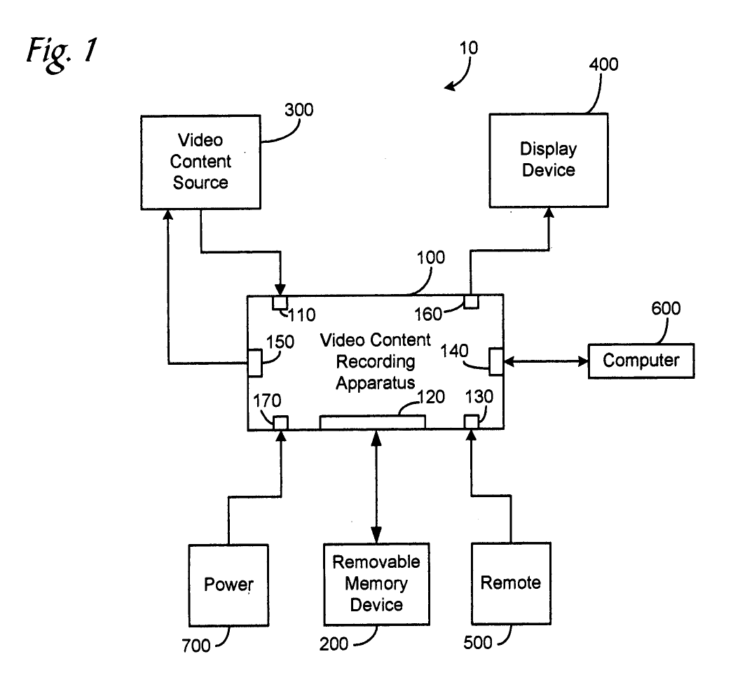

Turning now to the drawings, FIG. 1 is an illustration of a system 10 of an embodiment for recording video content. Video content can take any suitable form. In many situations, video content contains moving images; however, in some situations, video content can contain one or more still images. Examples of video content include, but are not limited to, a cable television broadcast, a satellite television broadcast, a terrestrial (i.e., “over-the-air”) television broadcast, or a video output from a VCR, DVD player, camcorder, camera/video phone, personal or digital video recorder (e.g., TiVo™), game player, or personal computer (e.g., an Internet broadcast). Video content can be in analog or digital form and converted from one form to another.

Video content is most often, but not always, associated with audio content that is played in a synchronized fashion with the video content. To simplify the discussion of these embodiments, audio content will not be treated in as much detail as video content. It should be kept in mind, however, that when an action or element is described in the following description and claims solely in the context of video content, no assumptions should be made regarding whether or not that action or element also relates to audio content. For example, when it is said that video content is recorded and played back, no assumption should be made as to whether or not audio content is also being recorded and played back.

Referring back to FIG. 1, the system 10 comprises a video content recording apparatus 100, a removable memory device 200, a video content source 300, a display device 400, a remote control device 500, a computer 600 and a power supply 700. The video content recording apparatus 100 will be described in more detail below.

A “removable memory device” refers to a storage device that can be placed in/on and removed from the video content recording apparatus 100. A removable memory device 200 can take any suitable form, and it is presently preferred that the removable memory device 200 take the form of a non-volatile, solid-state memory device, such as a flash memory card. Memory cards of a particular type typically conform to a standard size and format and are interchangeable in the sense that they can be inserted and removed from a variety of host devices. Suitable flash memory cards include, but are not limited to, the following memory cards: SD™, SD™(HC), MiniSD™(HC), MMC™, MMCplus™, MMCmobile™, MicroSD™(HC), Memory Stick™, Memory Stick PRO™, Memory Stick Duo™, and Memory Stick PRO Duo™. A USB memory device can also be used. Any suitable type of memory array can be used in a solid-state memory device, including a write-many or write-once two-dimensional or three-dimensional array, made from any suitable material. While it is presently preferred that the removable memory device 200 be a solid-state memory device, other removable memory devices can be used, such as, but not limited to, an optical disc and a magnetic disk.

A video content source 300 is any device that provides video content. Examples of a video content source include, but are not limited to, a cable tuner box, a satellite tuner box, a digital video broadcasting (DVB) tuner box, a terrestrial antenna, a set-top box, a VCR, a DVD player, a camcorder, a digital camera, a camera/video phone, a personal or digital video recorder (e.g., TiVo™), a game player, or a personal computer. The video content source 300 can provide video content in analog or digital form. A display device 400 can be a monitor or television, for example. In some situations, the video content source 300 is part of the display device 400, such as when the display device 400 is a television with a built-in tuner. The remote control device 500 is typically a wireless handheld user interface device used to communicate user commands to the video content recording apparatus 100. The computer 600 can be any suitable computing device, and the power supply 700 can be AC or a battery or both.

As shown in FIG. 1, the video content recording apparatus 100 comprises a variety of inputs and outputs to place the video content recording apparatus 100 in communication with other components. It should be noted that the video content recording apparatus 100 can contain additional or different inputs and outputs. It should also be noted that even though the term “input” and “output” are used and one-way arrows are sometimes used in the drawings, in some situations, there can be two-way communication between the video content recording apparatus 100 and the component connected via the input/output. Also, any suitable type of input or output can be used, and the terms input and output should be not restricted to the examples set forth in this description. Further, while the inputs and outputs are described herein as “first input,” “first output,” “second input,” etc., the first and second inputs (or outputs), for example, are not necessarily the same type of inputs (or outputs) just because the word “input” (or “output”) is used. For example, one input can be a physical connector, while another input can be an infrared receiver.

The video content recording apparatus 100 comprises a first input 110 configured to receive video content from the video content source 300. Although any suitable input can be used, it is presently preferred that the first input be a composite video input. Composite video combines the three basic elements of a video picture (color, brightness, and synchronization data) into a single combined signal and is commonly used in consumer video equipment. The video content recording apparatus 100 also comprises a second input 120 configured to receive the removable memory device 200. When the removable memory device 200 takes the form of a memory card, the second input 120 can be a slot in the video content recording apparatus 100 that contains an electrical connector that mates with a mating connector on the memory card. The second input 120 can be adapted for any suitable removable memory device (e.g., the second input 120 can be a tray for receiving an optical disc). Although only a single second input 120 is shown in FIG. 1, it should be understood that the video content recording apparatus 100 can contain inputs for a plurality of removable memory devices of the same type or of different types.

The video content recording apparatus 100 further comprises a third input 130 configured to receive user input. As shown in FIG. 1, the third input 130 can be configured to receive a communication from the remote 500. For example, the third input 130 can be an infrared receiver that receives infrared transmissions from the remote 500; however, other inputs can be used (e.g., a physical connector if the remote 500 is wired to the video content recording apparatus 100 with an electrical or optical cable). The third input 130 can also be one or more buttons or other types of user interface elements on the apparatus 100 itself. As yet another alternative, the third input 130 can comprise both user interface elements on the apparatus 100 itself as well as be configured to receive a communication from the remote 500. In other words, the third input 130 can take any form to allow a user to provide input to the apparatus 100 where some or all of the user interface elements (e.g., buttons, switches, etc.) can be on the remote 500 or on the apparatus 100 itself (or any other component). In this way, all of the user interface elements can be on the remote 500, all of the user interface elements can be on the apparatus 100 itself, or there can be a mix of user interface elements on the remote 500 and the apparatus 100 itself.

The video content recording apparatus 100 also comprises a fourth input 140 configured to allow the apparatus 100 to be connected to the computer 600. It is presently preferred that the fourth input 140 be a USB connector. Although not shown, the video content recording apparatus 100 can comprise inputs (e.g., left and right channels) for audio content.

The video content recording apparatus 100 also has a number of outputs, such as the first output 150 that is configured to provide control information to the video content source 300. The first output 150 is preferably an infrared emitter that communicates control information to the video content source 300 via an infrared transmission, although other wireless technologies can be used. As an alternative to using wireless technology, the first output 150 can be physically connected to the video content source 300, e.g., via an electrical or optical cable. The second output 160 is configured to provide video content and other display output (e.g., a graphical user interface) to the display device 400 and is preferably a composite video output and, optionally, an HDTV output. The power input 170 receives power from the power supply 700. Although not shown, the video content recording apparatus 100 can comprise outputs (e.g., left and right channels) for audio content.

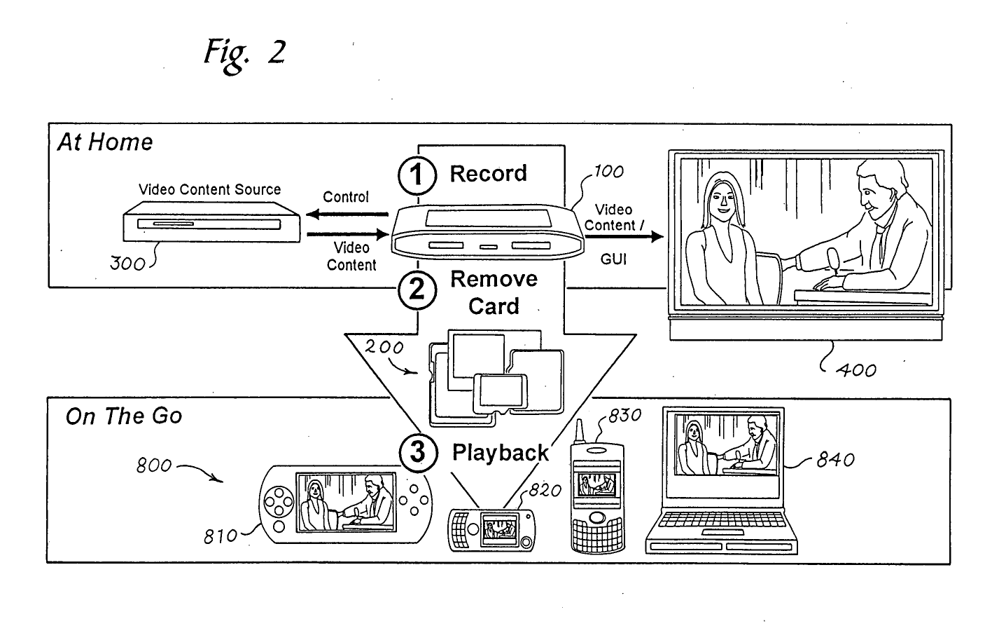

FIG. 2 illustrates the operation of one embodiment of the video content recording system 10. In this embodiment, the video content recording apparatus 100 takes the form of a “video memory card recorder,” and the removable memory device 200 takes the form of a flash memory card. (As shown in FIG. 2, the video memory card recorder has a plurality of card slots to support different types of memory cards.) The video content recording apparatus 100 has similar recording and playback functionality as a video cassette recorder (“VCR”) but uses flash memory cards instead of VCR tapes.

As shown in FIG. 2, the first step is for the video content recording apparatus 100 to record video content from the video content source 300 directly onto the removable memory device 200. (In an alternate embodiment, the video recording apparatus 100 contains an additional storage device (or an existing storage device that is otherwise used for a different purpose) that allows video content to be stored (temporarily, as in a cache, or otherwise) before recording it onto the removable memory device.) If the recording is a scheduled recording, the video content recording apparatus 100 sends control information via the first output 150, e.g., an IR emitter, (see FIG. 1) to turn on the video content source 300 and select a channel. As with a VCR or a DVR, the scheduled recording can be based on channel, date, and start/stop times, including daily and weekly repeats. The video content recording apparatus 100 can display a graphical user interface (“GUI”) on the display device 400 to provide an easy way for a user to schedule a recording, as well as to playback video content and change settings. During the recording of the video content onto the removable memory device 200, the video content recording apparatus 100 can also display the video content on the display device, either in real-time or otherwise, such as when the user “pauses” and then resumes watching a live broadcast. The video content recording apparatus 100 can also have additional functionality, such as, but not limited to, playing back and archiving digital photos, playing back audio files, and, as described in more detail below, acting as a card reader for a computer.

After the recording, the user removes the removable memory device 200 from the video content recording apparatus 100 and inserts it into a playback device 800 for playback. A playback device can be any video-enabled device, such as but not limited to, a handheld game console 810 (e.g., the Sony PSP™ or the Nintendo DS™), a mobile phone 820, a smart phone 830, a PC/notebook computer 840, a portable media player, such as a SanDisk Sansa™ e200 Series MP3 player, a handheld computer or other video-enabled device (including, but not limited to, a Windows CE device), a set-top box, or a display device (e.g., a television) with playback functionality. A playback device can also be the same (or different) video content recording apparatus 100 that recorded the video content onto the removable memory device 200. Accordingly, as described in more detail below, video content can be recorded on the removable memory device 200 in a format that is both suitable for small screen sizes of portable playback devices as well as full-screen sizes of display devices.

As can be seen from the examples noted above, a playback device can perform functions in addition to playing back video content stored on the removable memory device 200. For example, the playback device can also play games, make telephone calls, receive email, or even record video content. Also, while it would be especially convenient for the playback device to contain an input for the removable memory device 200 (e.g., a memory card slot), so the user can just “plug in” the removable memory device 200 into the playback device, some playback devices may not contain such an input, such as some existing portable media players, or may not have an input for the type of memory device (e.g., memory card) used by the video content recording apparatus 100. In these situations, the user can transfer the video content from the removable memory device 200 first to an intermediary device, such as a personal computer 840, and then from the intermediary device to the ultimate playback device (e.g., using software on the intermediary device).

As can be seen from the illustration in FIG. 2, the video content recording apparatus 100 allows a user to store and watch video content when he wants and wherever he wants (e.g., on the road, during a commute, at a friend's house, etc.). By using the removable memory device 200 as a transport medium for video content, the video content recording apparatus 100 frees the user from the static viewing environment of his home. Also, unlike some existing DVRs that achieve video content portability by requiring a user to transfer the video content from the DVR to a personal computer, the video content recording apparatus 100 records the video content directly onto the removable media device 200 without requiring a personal computer. Using a removable media device 200 to provide video content to a playback device is also faster and less expensive than subscribing to pricey wireless video services for mobile phones and avoids the uncertainty of whether a wireless connection will be present while a user is roaming. Further, since solid-state memory devices, such as flash cards, can store video content more reliably and for a longer time than videocassette tapes, the video content recording apparatus 100 also provides the advantage of being able to archive precious video content on a more durable medium.

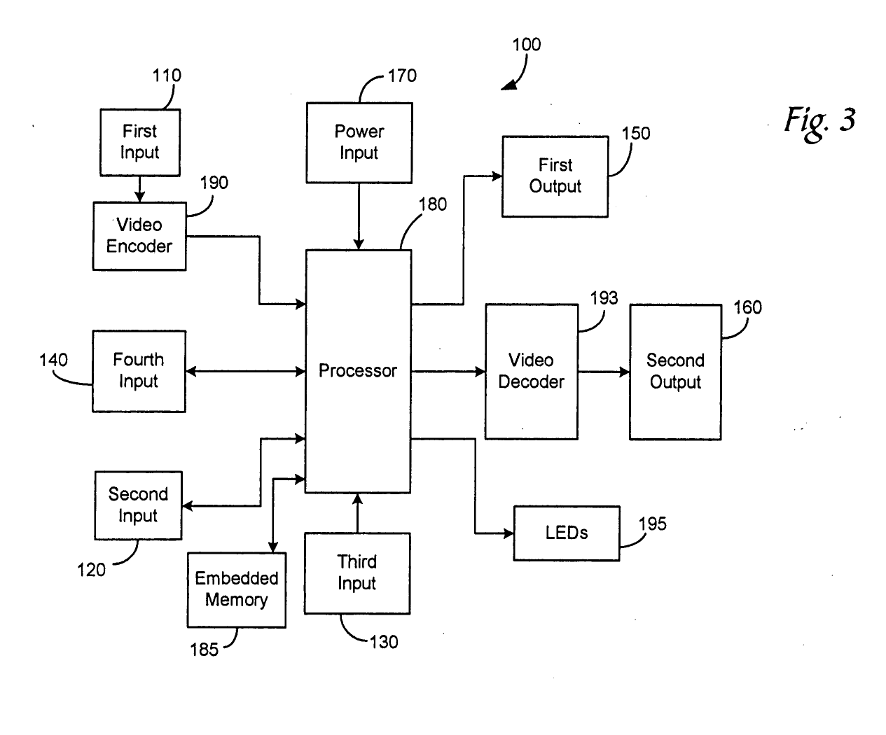

Returning to the drawings, FIG. 3 is a block diagram of the some of the components of the video content recording apparatus 100 of an embodiment. It should be noted that the video content recording apparatus 100 can contain additional or different components than the ones shown in FIG. 3. Also, it is presently preferred that the various inputs, outputs, and components be carried by a housing (an input or output protruding from the housing is still “carried by” the housing). In an alternate embodiment, one or more of the various inputs, outputs, and components are distributed among two or more housings.

As shown in FIG. 3, in addition to the inputs and outputs shown in FIG. 1, the video content recording apparatus 100 comprises a processor 180, embedded memory 185 (e.g., EEPROM or NAND memory), a video encoder 190, a video decoder 193, and LEDs 195. The LEDs can contain a power LED to indicate that the apparatus 100 is on/off, a removable memory device LED to indicate that a removable memory device is recognized/present and ready for transmission, a transmission LED that blinks when data is being transferred, and a recording/warning LED that is on during recording and blinks when there is not enough storage space on the removable memory device or when no removable memory device is present when recording is requested. In one embodiment, an LED is used next to the second input 120 to both indicate the presence of the memory device 200 (e.g., when the LED is continuously on) and to indicate data transfer (e.g., when the LED is blinking).

With reference now to both FIGS. 1 and 3, in operation, based on a recording request, the processor 180 sends control information via the first output 150 to the video content source 300 to turn on the video content source 300 and select a channel. The video content provided by the video content source 300 is sent to the video encoder 190. In this embodiment, the video content is outputted as an analog signal from the video content source 300, and the video encoder 190 converts the analog signal to a digital signal and provides the digital signal to the processor 180. (The video decoder 193 is used for the reverse operation—to convert the digital signal provided by the processor 180 to an analog signal used by the display device 400.) The processor 180 processes the digital signal and records it (preferably, in a compressed format) on the removable memory device 200. Because playback devices vary in video/audio codec support, file format support, screen resolution/orientation, frame rate, bit rate, video processing, card format support, and folder name/structure, it is preferred that the video content recording apparatus 100 know these video content recording parameters upfront in order to create the appropriate video content file and record it in such a way on the removable memory device 200 to make the video content compatible with a target playback device. As used herein, the term “video content recording parameter” refers to a parameter used in recording video content. Examples of a video content recording parameter include, but are not limited to, a video codec parameter, an audio codec parameter, a file format parameter, a file wrapper parameter, frame rate (e.g., frames per second), video bit rate, audio bit rate, audio bit rate variation, a video processing parameter, screen resolution, screen orientation, card format, folder structure, and folder name.

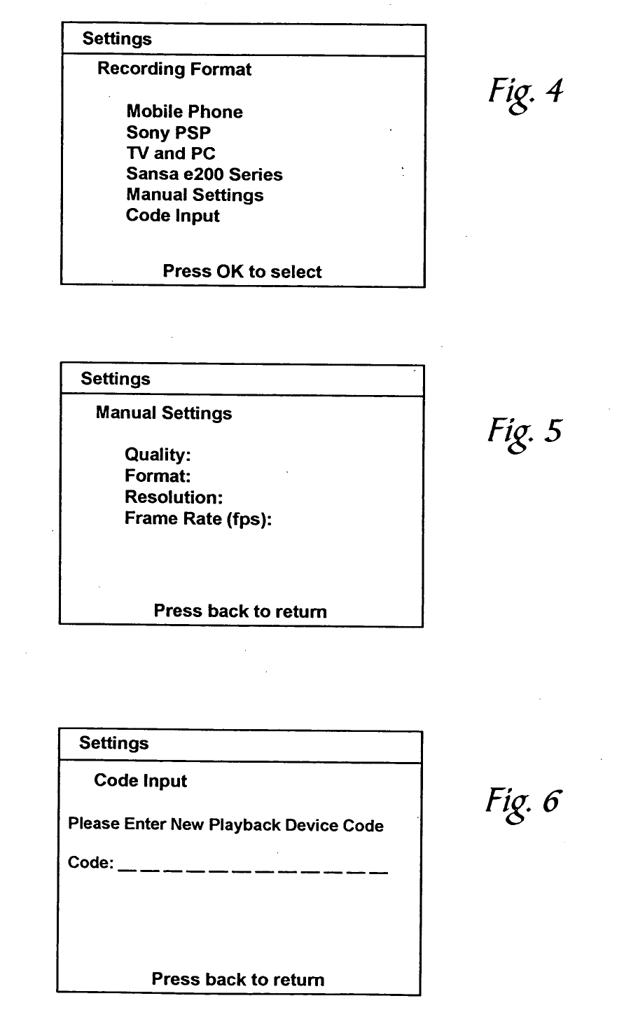

In this embodiment, video content recording parameters (and values for those parameters) for a plurality of playback devices are stored in a database in the firmware stored in the embedded memory 185. In operation, a user selects a target playback device (such as a mobile phone or a handheld game device) using the remote control device 500 and a graphical user interface displayed on the display device 400. FIG. 4 is an illustration of a display screen of the graphical user interface that facilitates user selection of one of a plurality of playback devices (e.g., mobile phone, Sony PSP™, TV and PC, Sansa™ e200 Series). After the user makes a selection, the processor 180 selects the corresponding video content recording parameter (and associated values) for that playback device from the database stored in the firmware. The processor 180 then processes and records the video content in the removable media device 200 in accordance with the values of those parameters (e.g., compress the video content into MPEG-4 format and use a certain file format designated for the target playback device).

As new playback devices are introduced, the video content recording parameters in the firmware can become outdated, requiring a firmware upgrade. (The firmware can contain additional functionality (such as a GUI program), so firmware upgrades may be desired for other reasons.) A firmware upgrade can be stored on a removable memory device. For example, a user can download the upgrade from a web site using a computer and then use the computer to copy the upgrade onto the removable memory device. The removable memory device that is used to stored the upgrade can be the same memory device or a different memory device from the one that is used to store video content. When the removable memory device is inserted into the video content recording apparatus 100, the video content recording apparatus 100 receives the upgrade and upgrades the firmware. Instead using the removable memory device as a transport medium for the upgrade, the upgrade can be transferred directly from the computer to the video content recording apparatus 100 via the fourth input 140 (e.g., a USB connection). (The fourth input 140 can also be used to allow the video content recording apparatus 100 to be used as a memory card reader for a computer.) When using the fourth input 140 to connect to a computer, it is possible for the upgrade to be saved directly onto the embedded memory, such as when the upgrade overwrites the exiting firmware or when an additional version is installed. The embedded memory can then appear on the desktop computer as one driver letter, with the removable memory device in the apparatus 100 appearing as a second driver letter. After upgrading the firmware, the video content recording apparatus 100 can reboot itself automatically or wait until the user performs a manual reboot.

Because new playback devices are constantly being introduced, the video content recording parameters in the original or upgraded firmware may become quickly outdated. The firmware may even be outdated before the video content recording apparatus 100 is sold to a user. A user may find it inconvenient to perform a complete firmware upgrade to accommodate his playback device. Also, a firmware upgrade that covers a new playback device may not be immediately available, especially for the newest playback devices. To accommodate the user in these situations, the video content recording apparatus 100 allows the user to manually enter values of video content recording parameters for a new playback device. Referred again to FIG. 4, the graphical user interface provides the user with a “manual settings” option. If the user selects that option, a new display screen is presented (see FIG. 5), requesting the user manually enter values of several video content recording parameters (here, quality, format, resolution, and frame rate). The user can learn of these values either in the product manual for the playback device (such as when the product manual is written after the firmware is stored) or from a web site, for example.

While manually inputting settings may be convenient for some users, other users may find it too cumbersome. Also, if the graphical user interface allows values to be entered for only a subset of video content recording parameters, the manually-entered settings may not be sufficient to provide complete compatibility with a target playback device. To overcome these difficulties, it is preferred that the video content recording apparatus 100 allow the user to input a simple code (e.g., via the third input 130 using the remote 500) that informs the video content recording apparatus 100 of the values of the video content recording parameters of a new target playback device. Referring again to FIG. 4, the graphical user interface provides the user with a “code input” option. If the user selects that option, a new display screen is presented (see FIG. 6) that requests the user to enter the code of the new playback device. In this preferred embodiment, the code is formatted in accordance with a syntax in which values of video content recording parameters are represented by characters arranged in a predefined order. More specifically, character positions in the code correspond to respective video content recording parameters, and a character in a character position represents a value of a video content recording parameter corresponding to that character position.

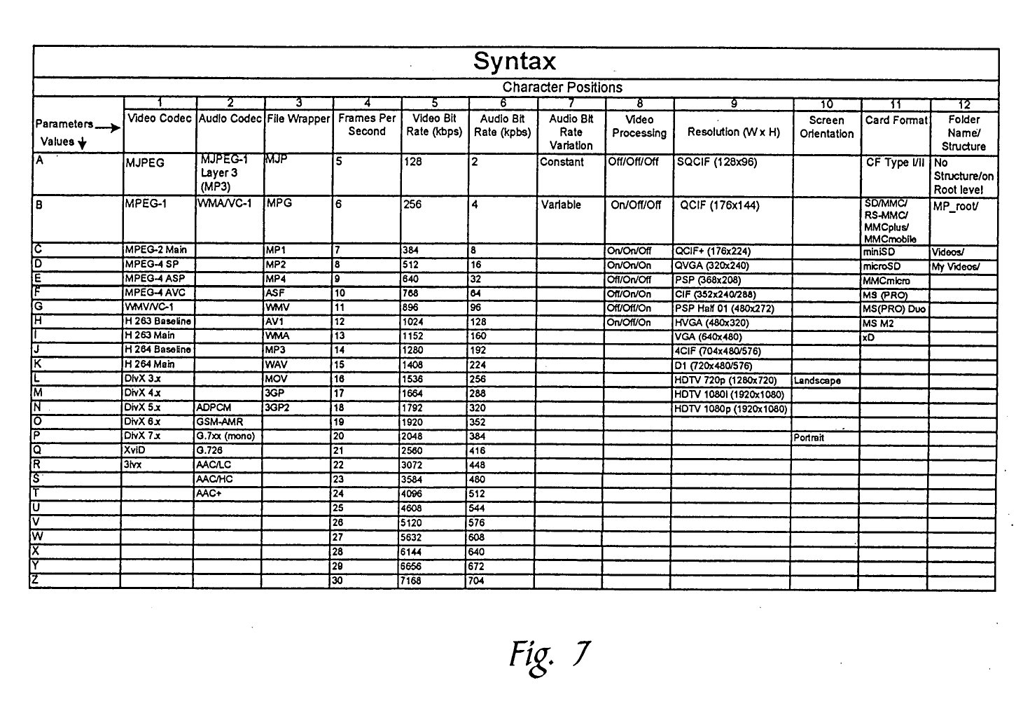

FIG. 7 is an illustration of a presently preferred syntax. As shown in FIG. 7, there are 12 character positions in this syntax, each representing a different video content recording parameter: a video codec parameter, an audio codec parameter, a file wrapper parameter, frame rate, video bit rate, audio bit rate, audio bit rate variation, a video processing parameter (e.g., quantization, pre-filter, and scene detection), screen resolution, screen orientation, card format, folder name/structure. The value of each parameter is represented here by a single character (in this embodiment, the character is a letter). Of course, other video content recording parameters can be used, such as the naming convention of a digital file containing the recorded video content. For example, the apparatus 100 can use a default naming convention for the digital file (e.g., YYMMDD-CHA-TTTT, where YY is the year, MM the month, DD the day, CHA is the three-digit channel, and TTTT the start time (e.g., 060831-003-1900)). A video content recording parameter can indicate whether to use the default or a customized naming convention that would be recognized by a target playback device.

In this embodiment, to provide the video content recording parameters to the video content recording apparatus 100, the user types-in a 12-character code using the remote 500. The firmware in the embedded memory 185 provides the processor 180 with the knowledge to understand the syntax and translate it appropriately. When the processor 180 receives the code, it can either store the code in the embedded memory 185 and translate the code every time it is needed, or it can translate the code once and store the translated parameter values in the embedded memory 185. Because the firmware knows the syntax (“language”) of the codes, there is no need to update the firmware even if a new playback device is introduced. (A later-installed firmware upgrade can include the new video content recording parameters, though.)

As an example, if the user enters the code DTEKDFBABLDA for a new playback device not supported by the existing firmware, the processor 180 would, at the appropriate time, translate the code as follows:
Parameter 1=D—Video Codec→MPEG-4 SP
Parameter 2=T—Audio Codec→AAC+
Parameter 3=E—File Wrapper→MP4
Parameter 4=K—Frame Rate→15
Parameter 5=D—Video Bit Rate→512
Parameter 6=F—Audio Bit Rate→64
Parameter 7=B—Audio Bit Rate Variation→Variable
Parameter 8=A—Video Processing→Quantization off/pre-filter off/scene detection off
Parameter 9=B—Screen Resolution→QCIF (176×144)
Parameter 10=L—Screen Orientation→Landscape
Parameter 11=D—Card Format→MicroSD™
Parameter 12=A—Folder Name/Structure→No structure/on root level

The processor 180 can then record the video content onto the removable memory device 200 in accordance with the values of the video content recording parameters specified by the code.

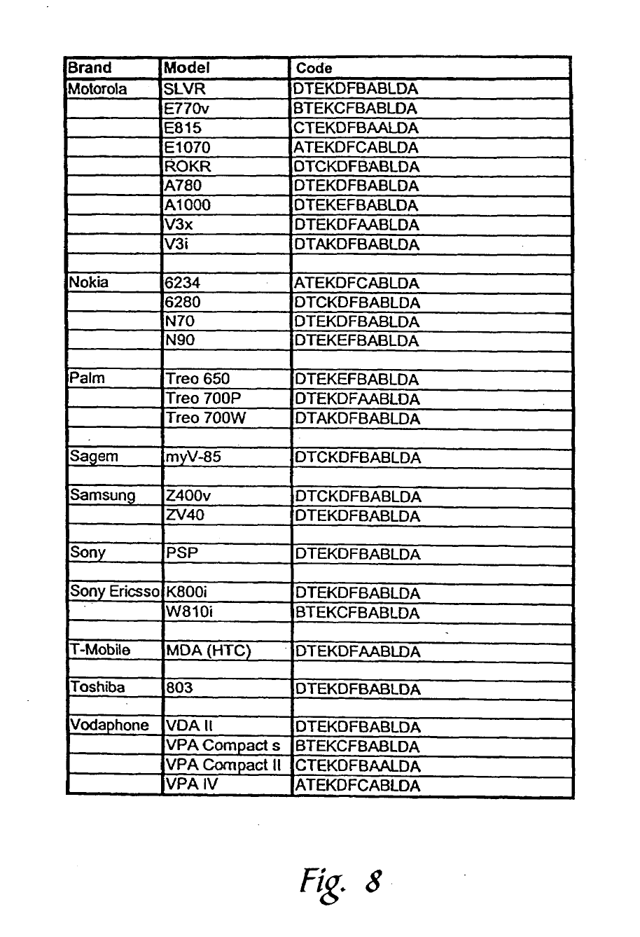

The code can be published and made available to users in any suitable manner. As used herein, the term “publish” means to disseminate in such a way as to make it available to a user. “Publish” does not necessarily mean disseminate in print form. For example, in situations where firmware is outdated even before the video recording apparatus 100 leaves the factory, codes for new playback devices can be listed in a table, such as the table in FIG. 8, included in a user guide that is packaged with the apparatus 100. (The codes in the table in FIG. 8 are merely for illustration purposes and are not necessarily accurate for the listed playback devices.) As another example, codes can published on a web site. For example, a table of codes can be published on the web site of the manufacturer of the apparatus, the web site of the manufacturer of the playback device, or another web site. In addition to a manufacturer determining what the code should be for a new device, users can determine and assist in publishing the code. For example, there can be an option on a web site for users to submit codes for new playback devices. If a certain number of users (e.g., three or more) submit the same code for a playback device, the web site can automatically update the list with the submitted playback device and code.

It should be noted that, while the syntax illustrated above used a single letter to represent a value of a video content recording parameter, other alternatives can be used. Accordingly, the term “character” is intended to broadly refer to any identifier that can be used to represent a value of a video content recording parameter. Examples of a “character” include, but are not limited to, a letter, a number, a symbol, a color, a sound (such as, for example, when DTMF tones generated by a phone or other device are used to input the characters or when voice-recognition technology is used to accept a speech input from a user), or any combination thereof. Also, while a single character in a character position was used in this embodiment to represent a value of a video content recording parameter, two or more characters in each character position can be used. For simplicity, when it is said that “a character in a character position represents a value of a video content recording parameter corresponding to that character position,” the “character” can be one or more characters, and the “character position” can be wide enough to hold the one or more characters. In other words, the phrase should not be limited to a single character in a one-character-wide character position. Accordingly, values of video content recording parameters are “represented by characters arranged in a predefined order” when the values are each represented by a single character or by more than one character.

Other alternatives and embodiments can be used with the embodiments described herein. For example, a “recording profile” can be stored on a removable memory device that informs a video content recording apparatus of the video content recording parameters that are to be used with that removable memory device. In operation, when the removable memory device is inserted into the video content recording apparatus, the processor could recognize the recording profile by its file extension and then use the video content recording parameters specified in that file to record video content on that memory device. In this way, a user can insert a memory device into his or another's video content recording apparatus, and the apparatus would know how to record the video content consistent with the user's playback device without requiring any further action by the user. This is especially advantageous when a single video content recording apparatus is used by multiple users, such as in a multi-user household with different users having different playback devices. The video content recording apparatus would automatically record video content for a particular playback device without a user having to manually select a target playback device. More generally, the video content recording apparatus can be configured to (1) always let the recording profile override previous settings, (2) never let the recording profile override previous settings, or (3) let the recording profile override previous settings after confirmation by the user. In the event that the recording profile is used, the video content recording apparatus can be configured to return to its previous video content recording parameters after the removable memory device is removed from the apparatus.

Finally, in the above embodiment, a processor and firmware were used to perform various functionality. Recognizing that there are alternatives to such an arrangement, the term “circuitry” is used as a more general descriptor for the one or more components that can be used to perform the operations discussed herein. For example, as above, “circuitry” can take the form of a processor executing computer-readable program code stored in a computer-readable medium (e.g., here, firmware stored in embedded memory). As noted above, the embedded memory can take the form of EEPROM or NAND memory, although other memory can be used. Also, computer-readable media other than embedded memory (such as, but not limited to, a hard drive, a removable memory device, etc.) can be used to store computer-readable program code. Accordingly, all or part of the computer-readable program code referred to herein as firmware can be software routines stored in embedded memory or in a storage device other than embedded memory. “Circuitry” can take other suitable forms, such as an application specific integrated circuit (ASIC), a programmable logic controller, an embedded microcontroller, and a single-board computer. Accordingly, the term “circuitry” should not be limited to any particular type of implementation, described herein or otherwise. Further, “circuitry” should not be limited to the functions described herein. For example, when circuitry takes the form of a processor executing firmware, as above, it should be understood that the processor can perform functions in addition to the ones described above.

It is intended that the foregoing detailed description be understood as an illustration of selected forms that the invention can take and not as a definition of the invention. It is only the following claims, including all equivalents, that are intended to define the scope of this invention. Finally, it should be noted that any aspect of any of the preferred embodiments described herein can be used alone or in combination with one another.

What is claimed is:

1. A method for recording video content onto a removable memory device, the method comprising:
receiving video content;
receiving a removable memory device;
receiving a code formatted in accordance with a syntax in which values of video content recording parameters are represented by characters arranged in a predefined order; and
recording the video content onto the removable memory device in accordance with the values of the video content recording parameters specified by the code.

2. The method of claim 1, wherein character positions in the code correspond to respective video content recording parameters, and wherein a character in a character position represents a value of a video content recording parameter corresponding to that character position.

3. The method of claim 1, wherein the video content recording parameters comprise one or more of the following: a video codec parameter, an audio codec parameter, a file format parameter, a file wrapper parameter, frame rate, video bit rate, audio bit rate, audio bit rate variation, a video processing parameter, screen resolution, screen orientation, card format, folder structure, folder name, and naming convention of a digital file containing recorded video content.

4. The method of claim 1, wherein the code is received via a remote control device.

5. The method of claim 1, wherein the code is received via at least one user interface element on a video content recording apparatus.

6. The method of claim 1 further comprising displaying, on a display device, a graphical user interface that facilitates user-entry of the code.

7. The method of claim 1, wherein the removable memory device comprises a removable solid-state memory card.

8. The method of claim 1 further comprising recording a recording profile on the removable memory device, the recording profile comprising values of video content recording parameters.

9. A method for providing a video content recording apparatus and video content recording parameters, the method comprising:
providing a video content recording apparatus comprising:
a first input configured to receive video content;
a second input configured to receive a removable memory device;
a third input configured to receive a code formatted in accordance with a syntax in which values of video content recording parameters are represented by characters arranged in a predefined order; and
circuitry operative to record the video content onto the removable memory device in accordance with the values of the video content recording parameters specified by the code; and
publishing the code.

10. The method of claim 9, wherein the code is published on the Internet.

11. The method of claim 9, wherein the code is published in a user guide provided with the apparatus.

12. The method of claim 9, wherein character positions in the code correspond to respective video content recording parameters, and wherein a character in a character position represents a value of a video content recording parameter corresponding to that character position.

13. The method of claim 9, wherein the video content recording parameters comprise one or more of the following: a video codec parameter, an audio codec parameter, a file format parameter, a file wrapper parameter, frame rate, video bit rate, audio bit rate, audio bit rate variation, a video processing parameter, screen resolution, screen orientation, card format, folder structure, folder name, and naming convention of a digital file containing recorded video content.

14. The method of claim 9, wherein the removable memory device comprises a removable solid-state memory card.

15. A method for recording video content onto a removable memory device, the method comprising:
displaying a graphical user interface that facilitates user entry of a code formatted in accordance with a syntax in which values of video content recording parameters are represented by characters arranged in a predefined order;
receiving the code; and
recording video content onto a removable memory device in accordance with the values of the video content recording parameters specified by the code.

16. The method of claim 15, wherein character positions in the code correspond to respective video content recording parameters, and wherein a character in a character position represents a value of a video content recording parameter corresponding to that character position.

17. The method of claim 15, wherein the video content recording parameters comprise one or more of the following: a video codec parameter, an audio codec parameter, a file format parameter, a file wrapper parameter, frame rate, video bit rate, audio bit rate, audio bit rate variation, a video processing parameter, screen resolution, screen orientation, card format, folder structure, folder name, and naming convention of a digital file containing recorded video content.

18. The method of claim 15, wherein the code is received via a remote control device.

19. The method of claim 15, wherein the code is received via at least one user interface element on a video content recording apparatus.

20. The method of claim 15, wherein the removable memory device comprises a removable solid-state memory card.

21. The method of claim 15, wherein the graphical user interface also facilitates user selection of a playback device.

22. The method of claim 15, wherein the graphical user interface also facilitates user entry of individual video content recording parameters.

23. The method of claim 15 further comprising recording a recording profile on the removable memory device, the recording profile comprising values of video content recording parameters.
